(19) United States
(12) Patent Application Publication
(10) Pub. No.: US 2022/0122326 A1
(43) Pub. Date: Apr. 21, 2022

(54) DETECTING OBJECT SURFACES IN EXTENDED REALITY ENVIRONMENTS

(71) Applicant: QUALCOMM Incorporated, San Diego, CA (US)

(72) Inventors: Gerhard REITMAYR, Del Mar, CA (US); Antonio Leonardo RODRIGUEZ LOPEZ, Amsterdam (NL)

(21) Appl. No.: 17/071,977

(22) Filed: Oct. 15, 2020

(51) Int. Cl. G06T 19/00; G06T 7/50; H04N 5/232

(52) U.S. Cl. CPC G06T 19/006; G06T 2207/10028; H04N 5/23238; G06T 7/50

(57) ABSTRACT

Techniques and systems are provided for detecting object surfaces in extended reality environments. In some examples, a system obtains image data associated with a portion of a scene within a field of view (FOV) of a device. The portion of the scene includes at least one object. The system determines, based on the image data, a depth map of the portion of the scene. The system also determines, using the depth map, one or more planes within the portion of the scene. The system then generates, using the one or more planes, at least one planar region with boundaries corresponding to boundaries of a surface of the at least one object. The system also generates a three-dimensional representation of the portion of the scene using the at least one planar region and updates a three-dimensional representation of the scene using the three-dimensional representation of the portion of the scene.

### FIELD

The present disclosure generally relates to image processing. In some examples, aspects of the present disclosure are related to detecting surfaces of objects within portions of scenes within extended reality environments and incrementally incorporating representations of the object surfaces into three-dimensional representations of the scenes.

### BACKGROUND

Extended reality technologies can be used to present virtual content to users, and/or can combine real environments from the physical world and virtual environments to provide users with extended reality experiences. The term extended reality can encompass virtual reality, augmented reality, mixed reality, and the like. Extended reality systems can allow users to experience extended reality environments by overlaying virtual content onto images of a real world environment, which can be viewed by a user through an extended reality device (e.g., a head-mounted display, extended reality glasses, or other device). To facilitate generating and overlaying virtual content, extended reality systems may attempt to detect and track objects within the user's real world environment. Specifically, some extended reality technologies may attempt to identify planes corresponding to surfaces of real world objects. It is important to accurately and efficiently detect object surfaces to improve the quality of extended reality environments.

### SUMMARY

Systems and techniques are described herein for detecting object surfaces in extended reality environments. According to at least one example, methods for detecting object surfaces in extended reality environments are provided. An example method can include obtaining image data associated with a portion of a scene within a field of view (FOV) of a device. The portion of the scene can include at least one object. The method can also include determining, based on the image data, a depth map of the portion of the scene within the FOV of the device including the at least one object. The method further includes determining, using the depth map, one or more planes within the portion of the scene within the FOV of the device including the at least one object. The method further includes generating, using the one or more planes, at least one planar region with boundaries corresponding to boundaries of a surface of the at least one object. The method includes generating, using the at least one planar region, a three-dimensional representation of the portion of the scene. The method further includes updating a three-dimensional representation of the scene using the three-dimensional representation of the portion of the scene. The three-dimensional representation of the scene can include additional representations of additional portions of the scene generated based on additional image data associated with the additional portions of the scene.

In another example, apparatuses are provided for detecting object surfaces in extended reality environments. An example apparatus can include memory and one or more processors (e.g., configured in circuitry) coupled to the memory. The one or more processors are configured to: obtain image data associated with a portion of a scene within a field of view (FOV) of the apparatus, the portion of the scene including at least one object; determine, based on the image data, a depth map of the portion of the scene within the FOV of the apparatus including the at least one object; determine, using the depth map, one or more planes within the portion of the scene within the FOV of the apparatus including the at least one object; generate, using the one or more planes, at least one planar region with boundaries corresponding to boundaries of a surface of the at least one object; generate, using the at least one planar region, a three-dimensional representation of the portion of the scene; and update a three-dimensional representation of the scene using the three-dimensional representation of the portion of the scene, the three-dimensional representation of the scene including additional representations of additional portions of the scene generated based on additional image data associated with the additional portions of the scene.

In another example, non-transitory computer-readable media are provided for detecting object surfaces in image frames. An example non-transitory computer-readable medium can store instructions that, when executed by one or more processors, cause the one or more processors to: obtain image data associated with a portion of a scene within a field of view (FOV) of the apparatus, the portion of the scene including at least one object; determine, based on the image data, a depth map of the portion of the scene within the FOV of the apparatus including the at least one object; determine, using the depth map, one or more planes within the portion of the scene within the FOV of the apparatus including the at least one object; generate, using the one or more planes, at least one planar region with boundaries corresponding to boundaries of a surface of the at least one object; generate, using the at least one planar region, a three-dimensional representation of the portion of the scene; and update a three-dimensional representation of the scene using the three-dimensional representation of the portion of the scene, the three-dimensional representation of the scene including additional representations of additional portions of the scene generated based on additional image data associated with the additional portions of the scene.

In another example, an apparatus for detecting object surfaces in image frames is provided. The apparatus includes: means for obtaining image data associated with a portion of a scene within a field of view (FOV) of a device, the portion of the scene including at least one object; means for determining, based on the image data, a depth map of the portion of the scene within the FOV of the device including the at least one object; means for determining, using the depth map, one or more planes within the portion of the scene within the FOV of the device including the at least one object; means for generating, using the one or more planes, at least one planar region with boundaries corresponding to boundaries of a surface of the at least one object; means for generating, using the at least one planar region, a three-dimensional representation of the portion of the scene; and means for updating a three-dimensional representation of the scene using the three-dimensional representation of the portion of the scene, the three-dimensional representation of the scene including additional representations of additional portions of the scene generated based on additional image data associated with the additional portions of the scene.

In some aspects, updating the three-dimensional representation of the scene using the three-dimensional representation of the portion of the scene can include adding the at least one planar region to the three-dimensional representation of the scene. Additionally or alternatively, updating the three-dimensional representation of the scene using the three-dimensional representation of the portion of the scene can include updating an existing planar region of the three-dimensional representation of the scene with the at least planar region. In some examples, the methods, apparatuses, and computer-readable medium described above can include generating the existing planar region of the three-dimensional representation of the scene using image data associated with an additional portion of the scene within an additional FOV of the device. In such examples, the FOV of the device may partially intersect the additional FOV of the device.

In some aspects, determining the depth map of the portion of the scene can include determining distances between points in the scene and the surface of the at least one object. In some examples, the distances can be represented using a signed distance function. In some aspects, the depth map includes a plurality of data points, each data point of the plurality of data points indicating a distance between an object surface and a point in the scene. In some cases, the depth map can be divided into a plurality of sub-volumes, each sub-volume of the plurality of sub-volumes including a predetermined number of data points.

In some examples, determining the one or more planes can include fitting a plane equation to data points within at least one sub-volume of the depth map. In some cases, the at least one sub-volume of the depth map can include a sub-volume corresponding to points in the scene that are less than a threshold distance from the surface of the at least one object.

In some examples, fitting the plane equation to the data points within the at least one sub-volume of the depth map can include: fitting a first plane equation to data points within a first sub-volume of the depth map and fitting a second plane equation to data points within a second sub-volume of the depth map; determining that the first plane equation has at least a threshold similarity to the second plane equation; determining, based on the first plane equation having at least the threshold similarity to the second plane equation, that the data points within the first sub-volume and the data points within the second sub-volume of the depth map correspond to a same plane; and based on determining that the data points within the first sub-volume and the data points within the second sub-volume correspond to the same plane, fitting a third plane equation to the data points within the first sub-volume and the data points within the second sub-volume, wherein the third plane equation is a combination of the first and second plane equations.

In some aspects, generating the at least one planar region can include: projecting one or more of the data points within the at least one sub-volume of the depth map onto a plane defined by the plane equation; and determining a polygon within the plane that includes the projected one or more data points. In some examples, determining the polygon within the plane can include determining a convex hull that includes the projected one or more data points and/or determining an alpha shape that includes the projected one or more data points.

In some aspects, the methods, apparatuses, and computer-readable media described herein can include, be part of, and/or be implemented by an extended reality device (e.g., a virtual reality device, an augmented reality device, and/or a mixed reality device), a mobile device (e.g., a mobile telephone or so-called “smart phone” or other mobile device), a wearable device, a personal computer, a laptop computer, a server computer, or other device. In some aspects, the apparatus includes a camera or multiple cameras for capturing one or more images. In some aspects, the apparatus includes a display for displaying one or more images, notifications, and/or other displayable data. In some aspects, the apparatuses described above can include one or more sensors (e.g., one or more accelerometers, gyroscopes, inertial measurement units (IMUs), motion detection sensors, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example architecture of an extended reality system, in accordance with some examples;

FIG. 2 is a block diagram illustrating an example of a system for detecting object surfaces in extended reality environments, in accordance with some examples;

FIG. 3A is a block diagram illustrating an example of a system for detecting object surfaces in extended reality environments, in accordance with some examples;

FIG. 3B and FIG. 3C are diagrams illustrating examples of detecting object surfaces in extended reality environments, in accordance with some examples;

FIG. 4 is a block diagram illustrating an example of a system for detecting object surfaces in extended reality environments, in accordance with some examples;

FIGS. 5A, 5B, 5C, and 5D are renderings illustrating examples of detecting object surfaces in extended reality environments, in accordance with some examples;

FIG. 6 is a flow diagram illustrating an example of a process for detecting object surfaces (e.g., in extended reality environments), in accordance with some examples; and

FIG. 7 is a diagram illustrating an example of a system for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

Extended reality (XR) systems can facilitate interaction with different types of XR environments, including virtual reality (VR) environments, augmented reality (AR) environments, mixed reality (MR) environments, and/or other XR environments. An XR device can be used by a user to interact with an XR environment. Examples of XR devices include head-mounted displays (HMDs), smart glasses, among others. For example, an XR system can cause virtual content to be overlaid onto images of a real world environment, which can be viewed by a user through an XR device (e.g., an HMD, XR glasses, or other XR device). The real world environment can include physical objects, people, or other real world objects. The XR device can track parts of the user (e.g., a hand and/or fingertips of a user) to allow the user to interact with items of virtual content.

Real world objects can complement virtual content that is present in an XR environment. For instance, a virtual coffee cup can be virtually anchored to (e.g., placed on top of) a real-world table in one or more images displayed during an XR session including an XR environment. People can also directly affect the virtual content and/or other real-world objects within the environment. For instance, a person can make a gesture simulating picking up the virtual coffee cup from the real-world table and then placing the virtual coffee cup back on the table. Further, some XR sessions may require and/or involve a person moving about the real world environment. For instance, an XR-based application may direct a user to navigate around nearby physical objects and/or incorporate the physical objects into their XR session. To facilitate interactions between a person and virtual content and/or physical objects, an XR system can detect and track locations of the physical objects. In particular, the XR system can determine locations of object surfaces. Determining object surfaces may enable the XR system to properly display virtual content relative to physical objects. For example, detecting the surface of the table may enable the XR system to display the coffee as appearing on top of the table (instead of appearing inside or behind the table). In addition, determining object surfaces may enable the user to avoid colliding with physical objects. For instance, after detecting the surface of the table, the XR system can direct the user to move around the table instead of making contact with the table. Further, information about object surfaces can enable the XR system to determine boundaries (e.g., walls) that delimit the operation area of an XR session. Accordingly it is important for an XR system to be capable of quickly and accurately tracking object surfaces as a person interacts with virtual content and/or real-world objects.

The present disclosure describes systems, apparatuses, methods, and computer-readable media (collectively referred to as “systems and techniques”) for detecting object surfaces. The systems and techniques described herein provide the ability for an XR system (e.g., an HMD, AR glasses, etc.) to determine planar regions (e.g., geometric shapes) corresponding to object surfaces within the real world environment in which the XR system is located. The XR system can incorporate the planar regions into a three-dimensional (3D) representation of the real world environment. In some cases, the XR system can incrementally generate and/or update the 3D representation. For instance, the XR system can determine geometric representations of object surfaces visible within a current field of view (FOV) of a camera integrated into the XR system and update a 3D representation of the real-world environment to include the representations of the object surfaces.

While examples are described herein using XR-based applications and XR systems, the systems and techniques are not limited to XR-based applications and related systems. For example, in some implementations, the systems and techniques for detecting object surfaces described herein can be implemented in various applications including, but not limited to, automotive, aircraft, and other vehicular applications, robotics applications, scene understanding and/or navigation applications, among others. In one illustrative example, the disclosed systems and techniques for detecting object surfaces can be used to facilitate collision avoidance for automobiles. For instance, the systems and techniques can detect structures (such as buildings, pedestrians, and/or other vehicles) that are nearby a moving vehicle. In another illustrative example, the disclosed systems and techniques can be used to detect suitable landing areas (such as horizontal planar surfaces of at least a certain size) for aircraft. In yet another example, the systems and techniques can be used by a robotic device (e.g., an autonomous vacuum cleaner, a surgical device, among others) to detect surfaces, such as so the robotic device can avoid a surface (e.g., navigate around the surface, etc.), focus on a surface (e.g., perform a procedure on the surface, etc.), and/or perform other functions with respect to a detected surface.

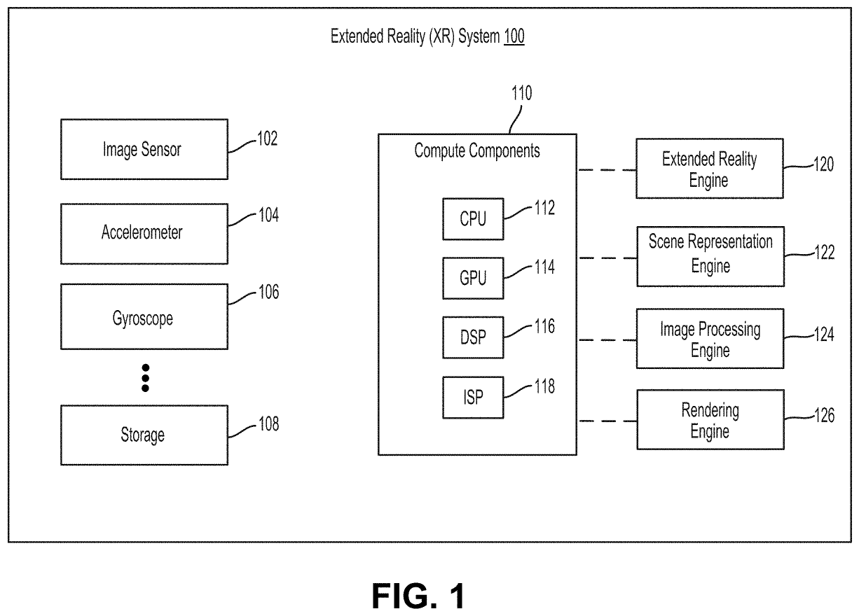

Further details regarding detecting object surfaces are provided herein with respect to various figures. FIG. 1 is a diagram illustrating an example extended reality system 100, in accordance with some aspects of the disclosure. The extended reality system 100 can run (or execute) XR applications and implement XR operations. In some examples, the extended reality system 100 can perform tracking and localization, mapping of the physical world (e.g., a scene), and positioning and rendering of virtual content on a display (e.g., a screen, visible plane/region, and/or other display) as part of an XR experience. For example, the extended reality system 100 can generate a map (e.g., 3D map) of a scene in the physical world, track a pose (e.g., location and position) of the extended reality system 100 relative to the scene (e.g., relative to the 3D map of the scene), position and/or anchor virtual content in a specific location(s) on the map of the scene, and render the virtual content on the display. The extended reality system 100 can render the virtual content on the display such that the virtual content appears to be at a location in the scene corresponding to the specific location on the map of the scene where the virtual content is positioned and/or anchored. In some examples, the display can include a glass, a screen, a lens, and/or other display mechanism that allows a user to see the real-world environment and also allows XR content to be displayed thereon.

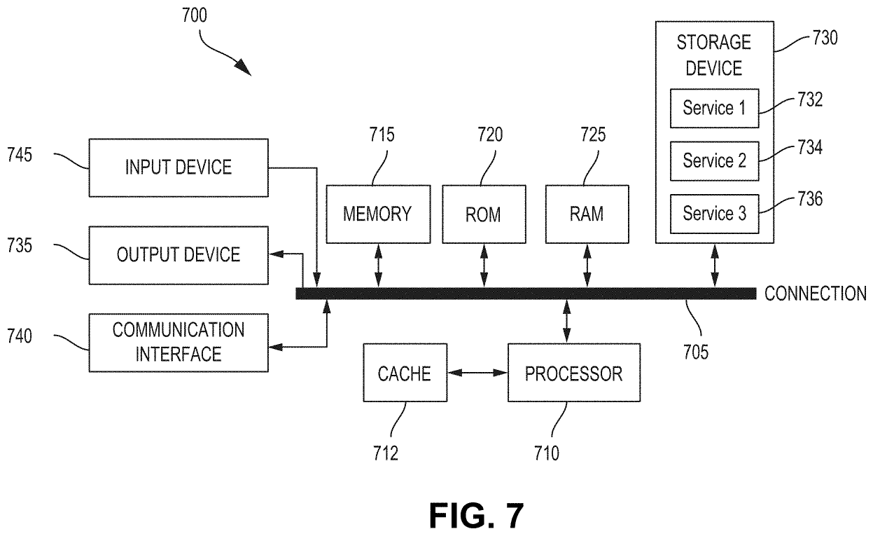

As shown in FIG. 1, the extended reality system 100 can include one or more image sensors 102, an accelerometer 104, a gyroscope 106, storage 108, compute components 110, an XR engine 120, a scene representation engine 122, an image processing engine 124, and a rendering engine 126. It should be noted that the components 102-126 shown in FIG. 1 are non-limiting examples provided for illustrative and explanation purposes, and other examples can include more, less, or different components than those shown in FIG. 1. For example, in some cases, the extended reality system 100 can include one or more other sensors (e.g., one or more inertial measurement units (IMUs), radars, light detection and ranging (LIDAR) sensors, audio sensors, etc.), one or more display devices, one more other processing engines, one or more other hardware components, and/or one or more other software and/or hardware components that are not shown in FIG. 1. An example architecture and example hardware components that can be implemented by the extended reality system 100 are further described below with respect to FIG. 7.

For simplicity and explanation purposes, the one or more image sensors 102 will be referenced herein as an image sensor 102 (e.g., in singular form). However, one of ordinary skill in the art will recognize that the extended reality system 100 can include a single image sensor or multiple image sensors. Also, references to any of the components (e.g., 102-126) of the extended reality system 100 in the singular or plural form should not be interpreted as limiting the number of such components implemented by the extended reality system 100 to one or more than one. For example, references to an accelerometer 104 in the singular form should not be interpreted as limiting the number of accelerometers implemented by the extended reality system 100 to one. One of ordinary skill in the art will recognize that, for any of the components 102-126 shown in FIG. 1, the extended reality system 100 can include only one of such component(s) or more than one of such component(s).

The extended reality system 100 includes or is in communication with (wired or wirelessly) an input device 108. The input device 108 can include any suitable input device, such as a touchscreen, a pen or other pointer device, a keyboard, a mouse a button or key, a microphone for receiving voice commands, a gesture input device for receiving gesture commands, any combination thereof, and/or other input device. In some cases, the image sensor 102 can capture images that can be processed for interpreting gesture commands.

The extended reality system 100 can be part of, or implemented by, a single computing device or multiple computing devices. In some examples, the extended reality system 100 can be part of an electronic device (or devices) such as an extended reality head-mounted display (HMD) device, extended reality glasses (e.g., augmented reality or AR glasses), a camera system (e.g., a digital camera, an IP camera, a video camera, a security camera, etc.), a telephone system (e.g., a smartphone, a cellular telephone, a conferencing system, etc.), a desktop computer, a laptop or notebook computer, a tablet computer, a set-top box, a smart television, a display device, a gaming console, a video streaming device, an Internet-of-Things (IoT) device, and/or any other suitable electronic device(s).

In some implementations, the one or more image sensors 102, the accelerometer 104, the gyroscope 106, storage 108, compute components 110, XR engine 120, a scene representation engine 122, image processing engine 124, and rendering engine 126 can be part of the same computing device. For example, in some cases, the one or more image sensors 102, the accelerometer 104, the gyroscope 106, storage 108, compute components 110, XR engine 120, a scene representation engine 122, image processing engine 124, and rendering engine 126 can be integrated into an HMD, extended reality glasses, smartphone, laptop, tablet computer, gaming system, and/or any other computing device. However, in some implementations, the one or more image sensors 102, the accelerometer 104, the gyroscope 106, storage 108, compute components 110, XR engine 120, a scene representation engine 122, image processing engine 124, and rendering engine 126 can be part of two or more separate computing devices. For example, in some cases, some of the components 102-126 can be part of, or implemented by, one computing device and the remaining components can be part of, or implemented by, one or more other computing devices.

The storage 108 can be any storage device(s) for storing data. Moreover, the storage 108 can store data from any of the components of the extended reality system 100. For example, the storage 108 can store data from the image sensor 102 (e.g., image or video data), data from the accelerometer 104 (e.g., measurements), data from the gyroscope 106 (e.g., measurements), data from the compute components 110 (e.g., processing parameters, preferences, virtual content, rendering content, scene maps, tracking and localization data, object detection data, privacy data, XR application data, face recognition data, occlusion data, etc.), data from the XR engine 120, data from the a scene representation engine 122, data from the image processing engine 124, and/or data from the rendering engine 126 (e.g., output frames). In some examples, the storage 108 can include a buffer for storing frames for processing by the compute components 110.

The one or more compute components 110 can include a central processing unit (CPU) 112, a graphics processing unit (GPU) 114, a digital signal processor (DSP) 116, and/or an image signal processor (ISP) 118. The compute components 110 can perform various operations such as image enhancement, computer vision, graphics rendering, extended reality (e.g., tracking, localization, pose estimation, mapping, content anchoring, content rendering, etc.), image/video processing, sensor processing, recognition (e.g., text recognition, facial recognition, object recognition, feature recognition, tracking or pattern recognition, scene recognition, occlusion detection, etc.), machine learning, filtering, and any of the various operations described herein. In this example, the compute components 110 implement the XR engine 120, the scene representation engine 122, the image processing engine 124, and the rendering engine 126. In other examples, the compute components 110 can also implement one or more other processing engines.

The image sensor 102 can include any image and/or video sensors or capturing devices. In some examples, the image sensor 102 can be part of a multiple-camera assembly, such as a dual-camera assembly. The image sensor 102 can capture image and/or video content (e.g., raw image and/or video data), which can then be processed by the compute components 110, the XR engine 120, the scene representation engine 122, the image processing engine 124, and/or the rendering engine 126 as described herein.

In some examples, the image sensor 102 can capture image data and can generate frames based on the image data and/or can provide the image data or frames to the XR engine 120, the scene representation engine 122, the image processing engine 124, and/or the rendering engine 126 for processing. A frame can include a video frame of a video sequence or a still image. A frame can include a pixel array representing a scene. For example, a frame can be a red-green-blue (RGB) frame having red, green, and blue color components per pixel; a luma, chroma-red, chroma-blue (YCbCr) frame having a luma component and two chroma (color) components (chroma-red and chroma-blue) per pixel; or any other suitable type of color or monochrome picture.

In some cases, the image sensor 102 (and/or other image sensor or camera of the extended reality system 100) can be configured to also capture depth information. For example, in some implementations, the image sensor 102 (and/or other camera) can include an RGB-depth (RGB-D) camera. In some cases, the extended reality system 100 can include one or more depth sensors (not shown) that are separate from the image sensor 102 (and/or other camera) and that can capture depth information. For instance, such a depth sensor can obtain depth information independently from the image sensor 102. In some examples, a depth sensor can be physically installed in a same general location the image sensor 102, but may operate at a different frequency or frame rate from the image sensor 102. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

As noted above, in some cases, the extended reality system 100 can also include one or more sensors (not shown) other than the image sensor 102. For instance, the one or more sensors can include one or more accelerometers (e.g., accelerometer 104), one or more gyroscopes (e.g., gyroscope 106), and/or other sensors. The one or more sensors can provide velocity, orientation, and/or other position-related information to the compute components 110. For example, the accelerometer 104 can detect acceleration by the extended reality system 100 and can generate acceleration measurements based on the detected acceleration. In some cases, the accelerometer 104 can provide one or more translational vectors (e.g., up/down, left/right, forward/back) that can be used for determining a position or pose of the extended reality system 100. The gyroscope 106 can detect and measure the orientation and angular velocity of the extended reality system 100. For example, the gyroscope 106 can be used to measure the pitch, roll, and yaw of the extended reality system 100. In some cases, the gyroscope 106 can provide one or more rotational vectors (e.g., pitch, yaw, roll). In some examples, the image sensor 102 and/or the XR engine 120 can use measurements obtained by the accelerometer 104 (e.g., one or more translational vectors) and/or the gyroscope 106 (e.g., one or more rotational vectors) to calculate the pose of the extended reality system 100. As previously noted, in other examples, the extended reality system 100 can also include other sensors, such as an inertial measurement unit (IMU), a magnetometer, a machine vision sensor, a smart scene sensor, a speech recognition sensor, an impact sensor, a shock sensor, a position sensor, a tilt sensor, etc.

In some cases, the one or more sensors can include at least one IMU. An IMU is an electronic device that measures the specific force, angular rate, and/or the orientation of the extended reality system 100, using a combination of one or more accelerometers, one or more gyroscopes, and/or one or more magnetometers. In some examples, the one or more sensors can output measured information associated with the capture of an image captured by the image sensor 102 (and/or other camera of the extended reality system 100) and/or depth information obtained using one or more depth sensors of the extended reality system 100.

The output of one or more sensors (e.g., the accelerometer 104, the gyroscope 106, one or more IMUS, and/or other sensors) can be used by the extended reality engine 120 to determine a pose of the extended reality system 100 (also referred to as the head pose) and/or the pose of the image sensor 102 (or other camera of the extended reality system 100). In some cases, the pose of the extended reality system 100 and the pose of the image sensor 102 (or other camera) can be the same. The pose of image sensor 102 refers to the position and orientation of the image sensor 102 relative to a frame of reference (e.g., with respect to the object 202). In some implementations, the camera pose can be determined for 6-Degrees Of Freedom (6DOF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference).

In some cases, a device tracker (not shown) can use the measurements from the one or more sensors and image data from the image sensor 102 to track a pose (e.g., a 6DOF pose) of the extended reality system 100. For example, the device tracker can fuse visual data (e.g., using a visual tracking solution) from captured image data with inertial measurement data to determine a position and motion of the extended reality system 100 relative to the physical world (e.g., the scene) and a map of the physical world. As described below, in some examples, when tracking the pose of the extended reality system 100, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the extended reality system 100 within the scene and the 3D map of the scene, etc. The 3D map can provide a digital representation of a scene in the real/physical world. In some examples, the 3D map can anchor location-based objects and/or content to real-world coordinates and/or objects. The extended reality system 100 can use a mapped scene (e.g., a scene in the physical world represented by, and/or associated with, a 3D map) to merge the physical and virtual worlds and/or merge virtual content or objects with the physical environment.

In some aspects, the pose of image sensor 102 and/or the extended reality system 100 as a whole can be determined and/or tracked by the compute components 110 using a visual tracking solution based on images captured by the image sensor 102 (and/or other camera of the extended reality system 100). For instance, in some examples, the compute components 110 can perform tracking using computer vision-based tracking, model-based tracking, and/or simultaneous localization and mapping (SLAM) techniques. For instance, the compute components 110 can perform SLAM or can be in communication (wired or wireless) with a SLAM engine (not shown). SLAM refers to a class of techniques where a map of an environment (e.g., a map of an environment being modeled by extended reality system 100) is created while simultaneously tracking the pose of a camera (e.g., image sensor 102) and/or the extended reality system 100 relative to that map. The map can be referred to as a SLAM map, and can be 3D. The SLAM techniques can be performed using color or grayscale image data captured by the image sensor 102 (and/or other camera of the extended reality system 100), and can be used to generate estimates of 6DOF pose measurements of the image sensor 102 and/or the extended reality system 100. Such a SLAM technique configured to perform 6DOF tracking can be referred to as 6DOF SLAM. In some cases, the output of the one or more sensors (e.g., the accelerometer 104, the gyroscope 106, one or more IMUS, and/or other sensors) can be used to estimate, correct, and/or otherwise adjust the estimated pose.

In some cases, the 6DOF SLAM (e.g., 6DOF tracking) can associate features observed from certain input images from the image sensor 102 (and/or other camera) to the SLAM map. For example, 6DOF SLAM can use feature point associations from an input image to determine the pose (position and orientation) of the image sensor 102 and/or extended reality system 100 for the input image. 6DOF mapping can also be performed to update the SLAM map. In some cases, the SLAM map maintained using the 6DOF SLAM can contain 3D feature points triangulated from two or more images. For example, key frames can be selected from input images or a video stream to represent an observed scene. For every key frame, a respective 6DOF camera pose associated with the image can be determined. The pose of the image sensor 102 and/or the extended reality system 100 can be determined by projecting features from the 3D SLAM map into an image or video frame and updating the camera pose from verified 2D-3D correspondences.

In one illustrative example, the compute components 110 can extract feature points from every input image or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The features points in key frames either match (are the same or correspond to) or fail to match the features points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Speed Up Robust Features (SURF), Gradient Location-Orientation histogram (GLOH), Normalized Cross Correlation (NCC), or other suitable technique.

In some cases, the extended reality system 100 can also track the hand and/or fingers of a user to allow the user to interact with and/or control virtual content in a virtual environment. For example, the extended reality system 100 can track a pose and/or movement of the hand and/or fingertips of the user to identify or translate user interactions with the virtual environment. The user interactions can include, for example and without limitation, moving an item of virtual content, resizing the item of virtual content and/or a location of the virtual private space, selecting an input interface element in a virtual user interface (e.g., a virtual representation of a mobile phone, a virtual keyboard, and/or other virtual interface), providing an input through a virtual user interface, etc.

The operations for the XR engine 120, the scene representation engine 122, the image processing engine 124, and the rendering engine 126 (and any image processing engines) can be implemented by any of the compute components 110. In one illustrative example, the operations of the rendering engine 126 can be implemented by the GPU 114, and the operations of the XR engine 120, the scene representation engine 122, and the image processing engine 124 can be implemented by the CPU 112, the DSP 116, and/or the ISP 118. In some cases, the compute components 110 can include other electronic circuits or hardware, computer software, firmware, or any combination thereof, to perform any of the various operations described herein.

In some examples, the XR engine 120 can perform XR operations to generate an XR experience based on data from the image sensor 102, the accelerometer 104, the gyroscope 106, and/or one or more sensors on the extended reality system 100, such as one or more IMUs, radars, etc. In some examples, the XR engine 120 can perform tracking, localization, pose estimation, mapping, content anchoring operations and/or any other XR operations/functionalities. An XR experience can include use of the extended reality system 100 to present XR content (e.g., virtual reality content, augmented reality content, mixed reality content, etc.) to a user during a virtual session. In some examples, the XR content and experience can be provided by the extended reality system 100 through an XR application (e.g., executed or implemented by the XR engine 120) that provides a specific XR experience such as, for example, an XR gaming experience, an XR classroom experience, an XR shopping experience, an XR entertainment experience, an XR activity (e.g., an operation, a troubleshooting activity, etc.), among others. During the XR experience, the user can view and/or interact with virtual content using the extended reality system 100. In some cases, the user can view and/or interact with the virtual content while also being able to view and/or interact with the physical environment around the user, allowing the user to have an immersive experience between the physical environment and virtual content mixed or integrated with the physical environment.

The scene representation engine 122 can perform various operations to generate and/or update representations of scenes in the real world environment around the user. A scene representation, as used herein, can include a digital or virtual depiction of all or a portion of the physical objects within a real world environment. In some cases, a scene representation can include representations of object surfaces. For example, a scene representation can include planar regions (e.g., two-dimensional polygons) corresponding to the shape, outline, and/or contour of object surfaces. A scene representation may include multiple representations of object surfaces for a single object (e.g., if the object is curved and/or corresponds to multiple planes within 3D space). In some examples, the scene representation engine 122 can incrementally generate and/or update a scene representation. For instance, the scene representation engine 122 can maintain and/or store (e.g., within a cache, non-volatile memory, and/or other storage) a partial representation of a scene and update the partial representation of the scene as more information about surfaces within the real world environment is determined. As will be explained below, the scene representation engine 122 can update a partial scene representation in response to the image sensor 102 capturing image data corresponding to new fields of view (FOVs) of the image sensor 102.

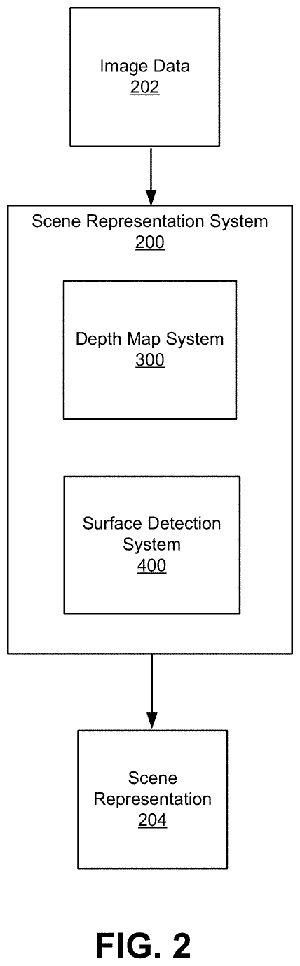

FIG. 2 is a block diagram illustrating an example of a scene representation system 200. In some cases, the scene representation system 200 can include and/or be part of the extended reality system 100 in FIG. 1. For instance, the scene representation system 200 can correspond to all or a portion of the scene representation engine 122. As shown in FIG. 2, the scene representation system 200 can receive, as input, image data 202. In one example, the image data 202 corresponds to one or more image frames captured by the image sensor 102. The scene representation system 200 can periodically or continuously receive captured image frames as a user of the extended reality system 100 interacts with virtual content provided by the extended reality system 100 and/or real world objects. The scene representation system 200 can process and/or analyze the image data 202 to generate a scene representation 204. The scene representation 204 can correspond to all or a portion of a 3D representation of the scene surrounding the user.

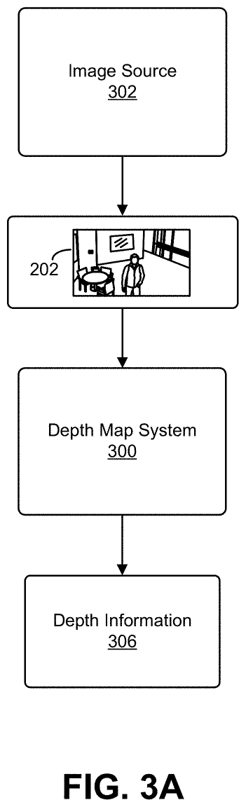

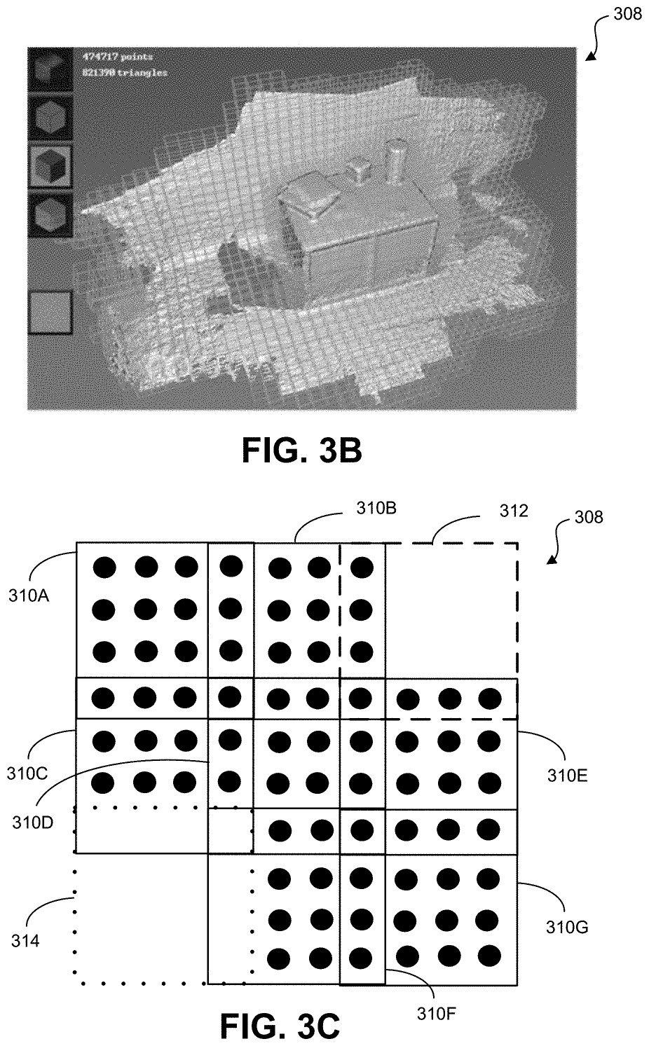

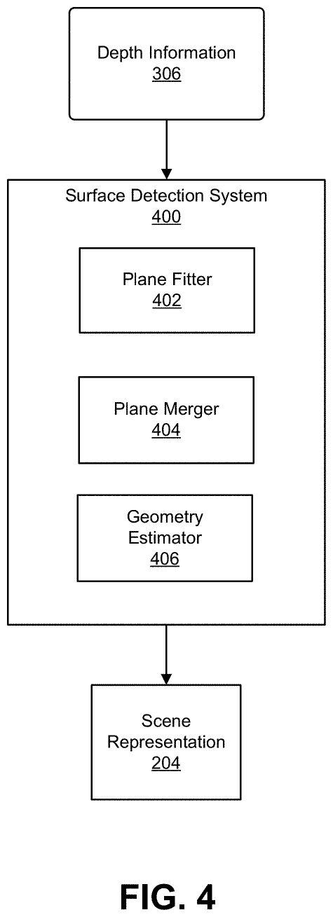

As shown in FIG. 2, the scene representation system 200 can include one or more additional systems, such as a depth map system 300 (also shown in FIG. 3) and a surface detection system 400 (also shown in FIG. 4). The depth map system 300 can obtain, extract, and/or otherwise determine depth information using the image data 202. For instance, as shown in FIG. 3, the depth map system 300 can generate depth information 306 based at least in part on the image data 202. The image data 202 can correspond to and/or depict an image source 302. For instance, the image source 302 can include one or more physical objects within the scene.

Depth information 306 can include any measurement or value that indicates and/or corresponds to a distance between a surface of a real world object and a point in physical space (e.g., a voxel). The depth map system 300 can represent such distances as a depth map including data points determined using various types of mathematical schemes and/or functions. In a non-limiting example, the depth map system 300 can represent the distances using a signed distance function, such as a truncated signed distance function. To implement a truncated signed distance function, the depth map system 300 can normalize distance values to fall within a predetermined range (e.g., a range of −1 to 1) that includes both negative and positive numbers. In some cases, positive distance values correspond to physical locations that are in front of a surface and negative distance values correspond to physical locations that are inside or behind a surface (e.g., from the perspective of a user and/or camera system, such as the image sensor 102 or other sensor of the extended reality system 100).

In some examples, the depth map system 300 can divide and/or organize the real world environment (or scene) into sub-volumes. A sub-volume (which may also be referred to a “block”) can include a predetermined number of data points (e.g., distance measurements). For example, a sub-volume or block can include 8 data points, 64 data points, 512 data points, or any other suitable number of data points. In a non-limiting example, each block can correspond to a three-dimensional section of physical space (e.g., a cube). Blocks may be of any alternative shape or configuration, including rectangular prisms and/or spheres. As will be explained below, dividing the real world environment into blocks can facilitate efficiently combining distance measurements corresponding to multiple FOVs.

FIG. 3B illustrates an example of a plurality of blocks 308. In some cases, the plurality of blocks 308 can be associated with depth information corresponding to physical locations nearby and/or tangent to the surfaces of real world objects within a scene. For instance, the depth map system 300 can obtain and record depth information (e.g., data points) associated with blocks most closely located to object surfaces. Thus, in some cases, the depth map system 300 can generate depth maps that do not include a distance measurement at every physical location (e.g., voxel) within a scene. For instance, it may be impractical and/or unnecessary to obtain depth information for voxels not within view (e.g., due to a limited FOV of a device, a physical object blocking the view of the voxel, etc.) of a user and/or a camera system (such as the image sensor 102 or other sensor of the extended reality system 100). Further, it may be impractical and/or unnecessary to obtain depth information corresponding to voxels that are not nearby object surfaces (e.g., voxels corresponding to empty space and/or that are beyond a certain distance from an object surface).

FIG. 3C illustrates an example of a two-dimensional cross section of a portion of the distance measurements associated with the plurality of blocks 308. For example, FIG. 3C represents distance measurements recorded for a cross-section of nine different blocks (e.g., blocks 310A, 310B, 310C, 310D, 310E, 310F, 310G, 312, and 314). Each of these blocks corresponds to a cube containing a number of distance measurements (e.g., 512 distance measurements). In a non-limiting example, the depth map system 300 can determine that at least a portion of the voxels within block 312 correspond to physical locations within and/or blocked by one or more physical objects. Thus, the depth map system 300 may not record distance information associated with those voxels. In addition, the depth map system 300 can determine that all or a portion of the voxels within blocks 310A-310G are tangent to and/or within a threshold distance from an object surface. The depth map system 300 may then record distance information associated with those voxels. Further, the depth map system 300 can determine that all or a portion of the voxels within block 314 exceed a threshold distance from an object surface. In such cases when the voxels exceed the threshold distance, the depth map system 300 may not record distance information associated with those voxels.

Moreover, as shown in FIG. 3C, individual blocks within the plurality of blocks 308 can overlap with one or more additional blocks. For instance, the four distance measurements on the right-hand side of block 310A (as displayed in FIG. 3C) correspond to the four distance measurements on the left-hand side of block 310B. Similarly, the bottom four distance measurements of block 310A correspond to the top four distance measurements of block 310C. In some cases, overlapping blocks can facilitate efficiently and/or accurately combining distance measurements to generate a depth map of a scene. For instance, the overlapping blocks can help ensure that distance measurements are accurate (e.g., based on comparisons with previous distance measurements) and/or help ensure that distance measurements are associated with appropriate voxels.

In some cases, the depth map system 300 can process and/or combine the depth information 306 to generate a depth map. As used herein, a depth map can include a numerical representation of distances between surfaces of objects in a scene and physical locations within the real world environment. In a non-limiting example, a depth map can correspond to a two-dimensional (2D) signal including a set of depth measurements. In some cases, the depth map system 300 can further process and/or transform a depth map. For instance, the depth map system 300 can generate a volumetric reconstruction (e.g., a 3D reconstruction) of all or a portion of a scene using a depth map of the scene. The depth map system 300 can generate a volumetric reconstruction using various techniques and/or functions. In a non-limiting example, the depth map system 300 can generate a volumetric reconstruction by combining and/or compiling distance measurements corresponding to multiple blocks of a depth map using volumetric fusion or a similar process. For instance, the depth map system 300 can implement a SLAM technique based on volumetric fusion. In some cases, generating a volumetric reconstruction of a scene can average and/or filter errors within a depth map, which may facilitate more accurate and/or more efficient processing of the information within the depth map. However, the disclosed systems and techniques may detect object surfaces without utilizing volumetric reconstructions. For instance, the surface detection system 400 (shown in FIG. 2 and FIG. 4) can detect surfaces of objects within a scene using a depth map of the scene and/or using a volumetric reconstruction of the scene.

FIG. 4A illustrates an example of the surface detection system 400 shown in FIG. 2. In some cases, the surface detection system 400 can receive, as input, the depth information 306 generated by the depth map system 300. The surface detection system 400 can process and/or analyze the depth information 306 to generate the scene representation 204. As shown in FIG. 4, the surface detection system 400 may include one or more modules or components, such as a plane fitter 402, a plane merger 404, and/or a geometry estimator 406. In some cases, the plane fitter 402 can determine one or more planes corresponding to the depth information 306. For instance, the plane fitter 402 can fit one or more plane equations to the distance measurements within blocks corresponding to the depth information 306. In a non-limiting example, the plane fitter 402 can fit a plane equation to the distance measurements within each individual block. Referring to FIG. 3C, the plane fitter 402 can fit a separate plane equation to the distance measurements within blocks 310A-310G. In some cases, a plane equation can be defined by a linear equation including at least three parameters (e.g., four parameters). In a non-limiting example, the plane fitter 402 can determine plane equations using the equation Xa=s, where X is a matrix containing 3D physical locations within the real world environment (e.g., voxel coordinates), a is a vector including four plane parameters, and s is a vector including distance measurements within a block. Thus, the components of the plane equations utilized by the plane fitter 402 can take the following form:

$$s = ( \begin{matrix}{s}_{1} \\ {s}_{2} \\ ⋮ \\ {s}_{n}\end{matrix} ) , a = ( \begin{matrix}a \\ b \\ c \\ d\end{matrix} ) , X = ( \begin{matrix}{x}_{1} & {y}_{1} & {z}_{1} & 1 \\ {x}_{2} & {y}_{2} & {z}_{2} & 1 \\ & ⋮ & & \\ {x}_{n} & {y}_{n} & {z}_{n} & 1\end{matrix} )$$

In some examples, the plane fitter 402 can transform the above-described plane equation to a reduced form. For instance, the plane fitter 402 can determine plane equations according to the equation X′a=s′, where X′ is a reduced coefficient matrix of size 4×4 and s′ is a reduced vector of size 4×1. This reduced plane equation can reduce the computation time and/or computation power involved in solving (and later merging) plane equations. However, the plane fitter 402 can implement any type or form of plane equation when determining planes corresponding to distance measurements.

In some cases, the plane merger 404 can merge one or more plane equations determined by the plane fitter 402. For instance, the plane merger 404 can merge plane equations corresponding to two adjacent blocks based on determining that the plane equations have at least a threshold degree of similarity. In some examples, determining whether two plane equations have at least the threshold degree of similarity includes determining whether the plane parameters (e.g., the vector a of each plane equation) have a threshold degree of similarity. The plane merger 404 can determine the similarity between the plane parameters of two plane equations in any suitable manner, such as by determining the distance between the planes. In addition, merging the plane equations can involve combining the plane coefficients for each plane equation (e.g., by summing the plane parameters). In some cases, the plane merger 404 can continue to combine plane equations of adjacent blocks until determining that a plane equation of an adjacent block does not have the threshold degree of similarity to the current merged plane equation and/or to one or more plane equations that have been merged. Referring to FIG. 3C, the plane merger 404 can determine that the plane equation for block 310A has the threshold degree of similarity to the plane equation for block 310B. Thus, the plane merger 404 can merge the two plane equations. However, if the plane merger 404 determines that the plane equation for block 310A does not have the threshold degree of similarity to the plane equation for block 310C, the plane merger 404 can determine to not merge the plane equation for block 310C with the plane equation corresponding to merging the plane equations for block 310A and block 310B. In some cases, the plane merger 404 can determine whether the plane equation for block 310A has the threshold degree of similarity to the plane equation for block 310D, and continue to merge plane equations appropriately in this manner.

In some cases, the geometry estimator 406 can determine geometric shapes corresponding to one or more merged plane equations. The determined geometric shapes can include planar regions corresponding to (or approximately corresponding to) object surfaces within the scene. The geometry estimator 406 can determine the planar regions in various ways and/or using various techniques. In one example, the geometry estimator 406 can identify each distance measurement corresponding to a merged plane equation. For instance, the geometry estimator 406 can identify 3D coordinates corresponding to each voxel within a group of blocks that have been merged to generate a merged plane equation. The geometry estimator 406 can then project the coordinates onto the plane corresponding to the merged plane equation. Because the blocks represent a sub-volume of 3D space, each voxel coordinate is not necessarily located within to the plane (which is a two-dimensional surface). Therefore, projecting the voxel coordinates onto the plane can enable the geometry estimator 406 to efficiently estimate a planar region that corresponds to at least a portion of an object surface.

In some cases, the geometry estimator 406 can determine that one or more voxels within the blocks corresponding to the merged plane equation do not correspond to the merged plane (or are likely to not correspond to the merged plane). For instance, the geometry estimator 406 can determine that one or more voxels exceed a threshold distance from the plane. Thus, the geometry estimator 406 can improve the estimation of the object surface by excluding the one or more voxels from the projection onto the plane.

Once the geometry estimator 406 projects the voxel coordinates (e.g., the relevant voxel coordinates) onto the plane, the geometry estimator 406 can determine a geometric shape (e.g., a polygon defined by one or more equations, lines, and/or curves) corresponding to the projected voxel coordinates. In a non-limiting example, the geometry estimator 406 can determine an alpha shape corresponding to the projected voxel coordinates. In another non-limiting example, the geometry estimator 406 can determine a convex hull corresponding to the projected voxel coordinates. In a further non-limiting example, the geometry estimator 406 can determine a Bezier curve corresponding to the projected voxel coordinates. The geometric shapes (e.g., planar regions) determined by the geometry estimator 406 can represent and/or be included within portions of the scene representation 204. For instance, each planar region defined within 3D space can represent all or a portion of a surface of an object within the real world environment.

In some examples, the scene representation system 200 (e.g., including the depth map system 300 and the surface detection system 400) can incrementally (e.g., periodically) update the scene representation 204. In these examples, the scene representation 204 may be an existing scene representation (e.g., an at least partially constructed scene representation) and the scene representation system 200 can incrementally update the existing scene representation. In some cases, the scene representation system 200 can incrementally update the scene representation 204 based on newly captured image frames. For instance, the scene representation 204 can be updated in response to all or a portion of the image frames captured by a camera system (such as the image sensor 102 or other sensor of the extended reality system 100) while a user is interacting with an XR system. In one example, the scene representation system 200 can update the scene representation 204 in response to receiving a predetermined number of new image frames (e.g., 1 new image frame, 5 new image frames, etc.). In another example, the scene representation system 200 can update the scene representation 204 in response to detecting that the FOV of the camera system has changed (e.g., in response to detecting that the image data currently captured by the camera system corresponds to a new portion of the scene). Additionally or alternatively, the scene representation system 200 can update the scene representation 204 on a fixed time schedule (e.g., every 0.25 seconds, every 0.5 seconds, every 1 second, etc.).

To facilitate incremental updates of the scene representation 204, all or a portion of the components of the scene representation system 200 can store their outputs within a portion of fast-access memory, such as a cache (e.g., a portion of Random Access Memory (RAM)) or other memory. The memory can be accessible to each component of the scene representation system 200, thereby enabling each component to utilize and/or update previously stored information. In some examples, in response to receiving one or more new image frames, the depth map system 300 can determine distance measurements corresponding to object surfaces depicted within the image frames. If the depth map system 300 determines that the new image frames include data corresponding to new voxels (e.g., voxels with no associated distance measurements), the depth map system 300 can store the new distance measurements within the memory (e.g., cache). In addition, if the depth map system 300 determines that the new image frames include data corresponding to voxels that have associated distance measurements, the depth map system 300 can update information stored within the memory if the depth map system 300 determines new (e.g., more accurate and/or recent) distance measurements associated with those voxels. Distance measurements associated with voxels not corresponding to the new image frames can remain constant (e.g., unchanged and/or un-accessed).

In some cases, the plane fitter 402 can determine plane equations for blocks whose associated distance measurements have been updated by the plane fitter 402. For instance, the plane fitter 402 can calculate (or re-calculate) plane equations for blocks that include new and/or updated distance measurements. If the plane fitter 402 determines new and/or updated plane equations, the plane fitter 402 can store the new and/or updated plane equations within the memory (e.g., cache). The plane merger 404 can then determine new and/or updated merged plane equations based on the new and/or updated plane equations. In some cases, the plane merger 404 can merge a new plane equation with a previously stored plane equation (e.g., a plane equation associated with a block not corresponding to the new image frames). Thus, the memory (e.g., cache) can enable the plane merger 404 to accurately determine merged plane equations associated with the current FOV without having to obtain and/or process distance measurements associated with blocks no longer within the current FOV. If the plane merger 404 determines new and/or updated merged plane equations, the plane merger 402 can store the new and/or updated merged plane equations within the memory. The geometry estimator 406 can determine new and/or updated planar regions based on the new and/or updated merged plane equations. In some cases, the geometry estimator 406 can determine that a new merged plane equation corresponds to a new planar region (e.g., a new object surface). In these cases, the geometry estimator 406 can update a 3D representation of the scene by adding the new planar region to the 3D representation of the scene. Additionally or alternatively, the geometry estimator 406 can determine that an updated merged plane equation corresponds to a newly detected portion of an existing (e.g., previously detected) planar region. In these cases, the geometry estimator 406 can update a 3D representation of the scene by updating the existing planar region. The geometry estimator 406 can store the new and/or updated planar regions within the memory (e.g., within the cache).

In some examples, the components of the scene representation system 200 can perform one or more of the above-described processes simultaneously. For instance, while the depth map system 300 determines depth information associated with a new image frame, the plane fitter 402 can determine new and/or updated plane equations associated with a previous image frame, the plane merger 404 can determine new and/or updated merged plane equations associated with another image frame, and so on, resulting in a pipeline process. In other examples, the components of the scene representation system 200 can perform one or more of the above-described processes sequentially. For instance, each step of updating the scene representation 204 can be performed for a single new image frame and/or new FOV before a subsequent image frame and/or FOV is analyzed. The pipeline technique and the sequential processing technique are both configured to produce fast and compute-efficient incremental updates to the scene representation 204. In either technique, efficient updates to the scene representation 204 can be facilitated by storing previously determined information (e.g., information about distance measurements, plane equations, and/or planar regions) within a portion of fast-access memory. For instance, the memory (e.g., cache or other memory) utilized by the scene representation system 200 can enable each component of the scene representation system 200 to process new image data while only accessing and/or updating previously stored information as necessary. In contrast, traditional systems for detecting object surfaces can require obtaining and/or re-processing image data associated with previous image frames and/or previous FOVs, which can result in exponentially greater compute times and compute power as new image data about a scene is obtained.

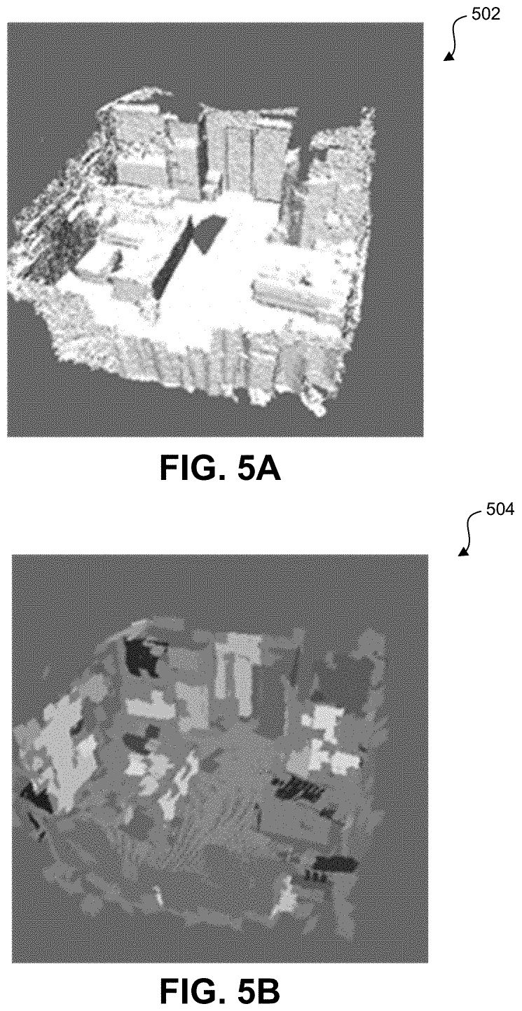

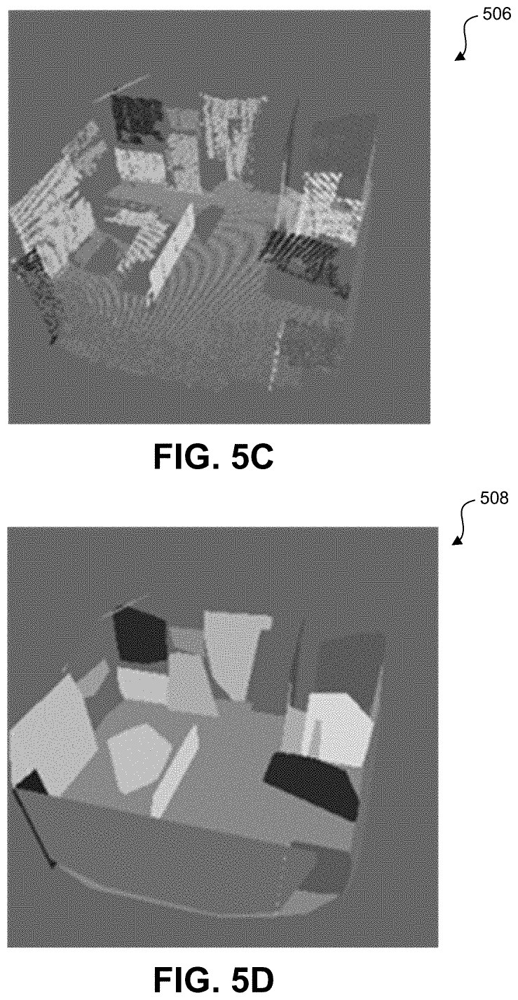

FIG. 5A, FIG. 5B, FIG. 5C, and FIG. 5D provide example visual illustrations of the processes for detecting object surfaces described herein. FIG. 5A illustrates an example of a volumetric reconstruction 502 associated with a scene. For instance, the visible areas of the volumetric reconstruction 502 can correspond to voxels for which the scene representation system 200 has determined distance measurements. FIG. 5B illustrates an example of planar surfaces 504 corresponding to merged plane equations. For instance, each distinct region within the planar surfaces 504 can represent one plane equation corresponding to a single block, or represent a merged plane equation corresponding to multiple blocks. The scene representation system 200 can determine the planar surfaces 504 based at least in part on the volumetric reconstruction 502.

FIG. 5C illustrates an example of projected coordinates 506. For instance, the individual points within the projected coordinates 506 can each correspond to a coordinate (e.g., a voxel coordinate) projected onto a plane (e.g., a merged plane corresponding to one or the planar surfaces 504). In addition, FIG. 5D illustrates an example of planar regions 508. For instance, each geometric region within the planar regions 508 can correspond to a geometric shape (e.g., a convex hull, alpha shape, or other polygon) corresponding to one or more of the projected coordinates 506. In some cases, the planar regions 508 correspond to all or a portion of the scene representation 204. Further, as described above, the scene representation system 200 can determine incremental updates to the scene representation 204 by periodically updating a memory (e.g., a cache and/or other memory) that stores information about the volumetric reconstruction 502, the planar surfaces 504, the projected coordinates 506, and/or the planar regions 508 as new image data associated with the scene is obtained.

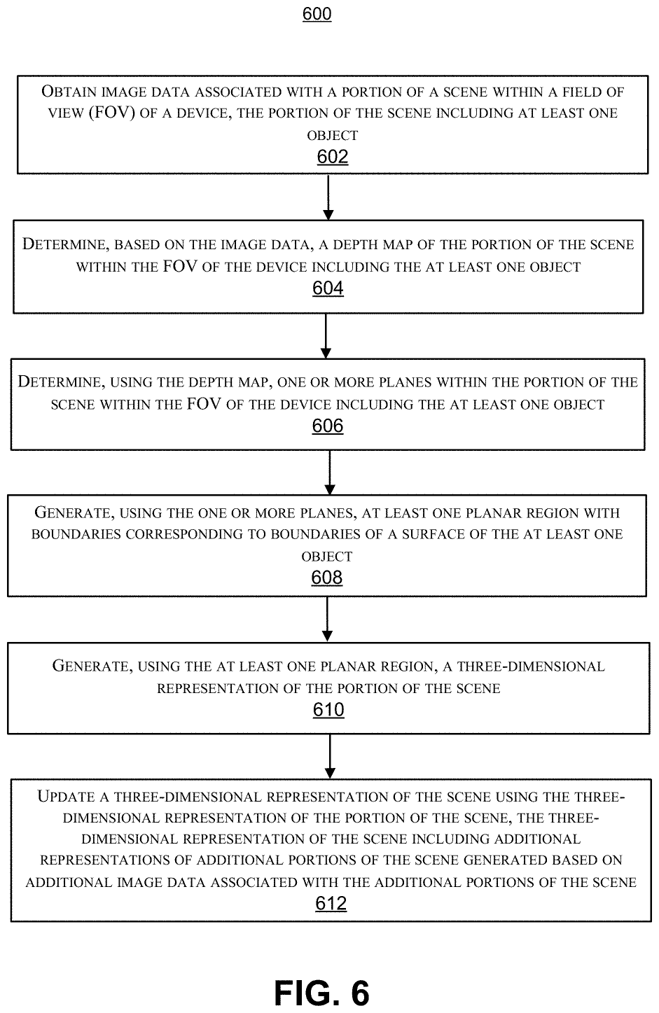

FIG. 6 is a flow diagram illustrating an example process 600 for detecting object surfaces in XR environments. For the sake of clarity, the process 600 is described with references to the scene representation system 200 shown in FIG. 2, the depth map system 300 shown in FIG. 3A, and the surface detection system 400 shown in FIG. 4. The steps or operations outlined herein are examples and can be implemented in any combination thereof, including combinations that exclude, add, or modify certain steps or operations.

At block 602, the process 600 includes obtaining image data associated with a portion of a scene within a field of view (FOV) of a device. The portion of the scene includes at least one object. For instance, the depth map system 300 can obtain the image data 202. The image data 202 can include one or more image frames associated with a portion of a scene within an FOV of a device (e.g., an XR device). In some examples, the depth map system 300 can obtain the image data 202 while a user interacts with virtual content provided by the device and/or real world objects.

At block 604, the process 600 includes determining, based on the image data, a depth map of the portion of the scene within the FOV of the device including the at least one object. In some examples, the process 600 can determine the depth map of the portion of the scene by determining distances between points in the scene and the surface of the at least one object. In some cases, the distances are represented using a signed distance function or other distance function. The depth map can include a plurality of data points. For example, each data point of the plurality of data points can indicate a distance between an object surface and a point in the scene. In some cases, the depth map is divided into a plurality of sub-volumes, as described above. Each sub-volume of the plurality of sub-volumes can include a predetermined number of data points.

In one illustrative example, the depth map system 300 can determine, based on the image data 202, the depth map of the portion of the scene. For instance, the depth map system 300 can generate depth information 306 based at least in part on the image data 202. The depth information 306 can include any measurement or value that indicates and/or corresponds to a distance between a surface of a real world object and a point in physical space (e.g., a voxel). In some cases, the depth map system 300 can store distance measurements within sub-volumes (e.g., cubes) that each correspond to a three-dimensional (3D) section of physical space. In one example, the depth map system 300 can store distance information for sub-volumes corresponding to physical locations nearby and/or tangent to the surfaces of real world objects within the scene. In some examples, the depth map system 300 can generate the depth map by combining and/or processing the distance measurements included in the depth information 306. In a non-limiting example, the depth map system 300 can generate a depth map that corresponds to a 2D signal including a set of distance measurements. In some cases, the depth map system 300 can further process and/or transform the depth map. For instance, the depth map system 300 can generate a volumetric reconstruction (e.g., a 3D reconstruction) of the portion of the scene using the depth map.

At block 606, the process 600 includes determining, using the depth map, one or more planes within the portion of the scene within the FOV of the device including the at least one object. For instance, the plane fitter 402 of the surface detection system 400 (shown in FIG. 4) can determine, using the depth map, the one or more planes within the portion of the scene. In some examples, the process 600 can determine the one or more planes by fitting one or more plane equations to data points within at least one sub-volume of the depth map. In some cases, the at least one sub-volume of the depth map includes a sub-volume corresponding to points in the scene that are less than a threshold distance from the surface of the at least one object. In one illustrative example, the plane fitter 402 can fit the one or more plane equations to the distance measurements included within depth information 306. If the depth map system 300 stores distance measurements within sub-volumes corresponding to physical locations, the plane fitter 402 can fit one plane equation to the distance measurements within each sub-volume.

In some examples, the process 600 can fit the plane equation to the data points within the at least one sub-volume of the depth map by fitting a first plane equation to data points within a first sub-volume of the depth map and fitting a second plane equation to data points within a second sub-volume of the depth map. The process 600 can include determining that the first plane equation has at least a threshold similarity to the second plane equation. The process 600 can also include determining, based on the first plane equation having at least the threshold similarity to the second plane equation, that the data points within the first sub-volume and the data points within the second sub-volume of the depth map correspond to a same plane. Based on determining that the data points within the first sub-volume and the data points within the second sub-volume correspond to the same plane, the process 600 can include fitting a third plane equation to the data points within the first sub-volume and the data points within the second sub-volume. The third plane equation is a combination of the first and second plane equations.

At block 608, the process 600 includes generating, using the one or more planes, at least one planar region with boundaries corresponding to boundaries of a surface of the at least one object. In some examples, the process 600 can generate the at least one planar region includes by projecting one or more of the data points within the at least one sub-volume of the depth map onto a plane defined by the plane equation. The process 600 can also include determining a polygon within the plane that includes the projected one or more data points. The process 600 can determine the polygon within the plane by determining a convex hull that includes the projected one or more data points, an alpha shape that includes the projected one or more data points, any combination thereof, and/or using another suitable technique for determining a polygon.

In one illustrative example, the plane merger 404 and the geometry estimator 406 of the surface detection system 400 (also shown in FIG. 4) can use the one or more planes to generate the at least one planar region with boundaries corresponding to boundaries of a surface of at least one object within the portion of the scene. For instance, the plane merger 404 can merge one or more plane equations associated with adjacent sub-volumes that have at least a threshold degree of similarity. In some cases, the plane merger 404 can determine that two plane equations have at least the threshold degree of similarity based on comparing the plane parameters of the plane equations. To merge the plane equations, the plane merger 404 can sum the plane parameters. In some cases, the geometry estimator 406 can determine a planar region with boundaries corresponding to boundaries of the surface of an object by determining a geometric shape corresponding to the data points (e.g., voxels) within a set of merged sub-volumes. For instance, the geometry estimator 406 can project the data points onto a plane defined by a merged plane equation. The geometry estimator 406 can then determine a shape (e.g., a polygon) corresponding to the outline of the projected coordinates.

At block 610, the process 600 includes generating, using the at least one planar region, a 3D representation of the portion of the scene. For example, the scene representation system 200 can generate, using the at least one planar region, the 3D representation of the portion of the scene. In some cases, each planar region generated by the plane merger 404 and/or the geometry estimator 406 can represent all or a portion of a surface of an object within the scene. The scene representation system 200 can utilize information associated with the location and/or orientation of the planar regions to determine where the object surfaces are located within the real world environment.

At block 612, the process 600 includes updating a 3D representation of the scene using the three-dimensional representation of the portion of the scene. For instance, the scene representation system 200 can update the 3D representation of the scene using the 3D representation of the portion of the scene. The 3D representation of the scene can include additional representations of additional portions of the scene generated based on additional image data associated with the additional portions of the scene. In some examples, updating the 3D representation of the scene using the 3D representation of the portion of the scene can include adding the at least one planar region to the 3D representation of the scene. In some examples, updating the 3D representation of the scene using the 3D representation of the portion of the scene includes updating an existing planar region of the 3D representation of the scene with the at least planar region. In some examples, the process 600 includes generating the existing planar region of the 3D representation of the scene using image data associated with an additional portion of the scene within an additional FOV of the device. In such examples, the FOV of the device may partially intersect the additional FOV of the device.

For instance, in some cases, the scene representation system 200 can incrementally incorporate newly generated 3D representations of portions of the scene into the 3D representation of the scene. In some examples, all or a portion of the components of the scene representation system 200 (e.g., the depth map system 300 and the surface detection system 400) can store their outputs within a portion of fast-access memory (e.g., a portion of RAM). Each component can access data stored within the portion of memory as needed. For example, the plane merger 404 can access plane equations generated and stored by the plane fitter 402. By storing data associated with previously generated 3D representations of the scene, the scene representation system 200 can efficiently update the 3D representation of the entire scene using image data associated with recently captured image frames (e.g., instead of determining a 3D representation of the entire scene in response to capturing a new image frame).

In some examples, the processes described herein (e.g., process 600 and/or other process described herein) may be performed by a computing device or apparatus. In one example, the process 600 can be performed by the scene representation system 200 shown in FIG. 2, the depth map system 300 shown in FIG. 3A, and/or the surface detection system 400 shown in FIG. 4. In another example, the process 600 can be performed by a computing device with the computing system 700 shown in FIG. 7. For instance, a computing device with the computing architecture shown in FIG. 7 can include the components of the scene representation system 200 and can implement the operations of FIG. 6.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the process 800. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 600 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 600 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 7 is a diagram illustrating an example of a system for implementing certain aspects of the present technology. In particular, FIG. 7 illustrates an example of computing system 700, which can be for example any computing device making up internal computing system, a remote computing system, a camera, or any component thereof in which the components of the system are in communication with each other using connection 705. Connection 705 can be a physical connection using a bus, or a direct connection into processor 710, such as in a chipset architecture. Connection 705 can also be a virtual connection, networked connection, or logical connection.

In some examples, computing system 700 is a distributed system in which the functions described in this disclosure can be distributed within a datacenter, multiple data centers, a peer network, etc. In some examples, one or more of the described system components represents many such components each performing some or all of the function for which the component is described. In some cases, the components can be physical or virtual devices.

Example system 700 includes at least one processing unit (CPU or processor) 710 and connection 705 that couples various system components including system memory 715, such as read-only memory (ROM) 720 and random access memory (RAM) 725 to processor 710. Computing system 700 can include a cache 712 of high-speed memory connected directly with, in close proximity to, or integrated as part of processor 710.

Processor 710 can include any general purpose processor and a hardware service or software service, such as services 732, 734, and 737 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 730 can include software services, servers, services, etc., that when the code that defines such software is executed by the processor 710, it causes the system to perform a function. In some examples, a hardware service that performs a particular function can include the software component stored in a computer-readable medium in connection with the necessary hardware components, such as processor 710, connection 705, output device 735, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

What is claimed is:

1. A method for detecting object surfaces, the method comprising:
obtaining image data associated with a portion of a scene within a field of view (FOV) of a device, the portion of the scene including at least one object;
determining, based on the image data, a depth map of the portion of the scene within the FOV of the device including the at least one object;
determining, using the depth map, one or more planes within the portion of the scene within the FOV of the device including the at least one object;
generating, using the one or more planes, at least one planar region with boundaries corresponding to boundaries of a surface of the at least one object;
generating, using the at least one planar region, a three-dimensional representation of the portion of the scene; and
updating a three-dimensional representation of the scene using the three-dimensional representation of the portion of the scene, the three-dimensional representation of the scene including additional representations of additional portions of the scene generated based on additional image data associated with the additional portions of the scene.

2. The method of claim 1, wherein updating the three-dimensional representation of the scene using the three-dimensional representation of the portion of the scene includes adding the at least one planar region to the three-dimensional representation of the scene.

3. The method of claim 1, wherein updating the three-dimensional representation of the scene using the three-dimensional representation of the portion of the scene includes updating an existing planar region of the three-dimensional representation of the scene with the at least planar region.

4. The method of claim 3, further comprising generating the existing planar region of the three-dimensional representation of the scene using image data associated with an additional portion of the scene within an additional FOV of the device, and wherein the FOV of the device partially intersects the additional FOV of the device.

5. The method of claim 1, wherein determining the depth map of the portion of the scene includes determining distances between points in the scene and the surface of the at least one object.

6. The method of claim 5, wherein the distances are represented using a signed distance function.

7. The method of claim 1, wherein the depth map includes a plurality of data points, each data point of the plurality of data points indicating a distance between an object surface and a point in the scene, and wherein the depth map is divided into a plurality of sub-volumes, each sub-volume of the plurality of sub-volumes including a predetermined number of data points.

8. The method of claim 7, wherein determining the one or more planes includes fitting a plane equation to data points within at least one sub-volume of the depth map.

9. The method of claim 8, wherein the at least one sub-volume of the depth map includes a sub-volume corresponding to points in the scene that are less than a threshold distance from the surface of the at least one object.

10. The method of claim 8, wherein fitting the plane equation to the data points within the at least one sub-volume of the depth map includes:
fitting a first plane equation to data points within a first sub-volume of the depth map and fitting a second plane equation to data points within a second sub-volume of the depth map;
determining that the first plane equation has at least a threshold similarity to the second plane equation;
determining, based on the first plane equation having at least the threshold similarity to the second plane equation, that the data points within the first sub-volume and the data points within the second sub-volume of the depth map correspond to a same plane; and
based on determining that the data points within the first sub-volume and the data points within the second sub-volume correspond to the same plane, fitting a third plane equation to the data points within the first sub-volume and the data points within the second sub-volume, wherein the third plane equation is a combination of the first and second plane equations.

11. The method of claim 8, wherein generating the at least one planar region includes:
projecting one or more of the data points within the at least one sub-volume of the depth map onto a plane defined by the plane equation; and
determining a polygon within the plane that includes the projected one or more data points.

12. The method of claim 11, wherein determining the polygon within the plane includes determining one of:
a convex hull that includes the projected one or more data points; or
an alpha shape that includes the projected one or more data points.

13. The method of claim 1, wherein the device is an extended reality device.

14. An apparatus for detecting object surfaces, the apparatus comprising:
a memory;
a processor coupled to the memory, the processor configured to:
obtain image data associated with a portion of a scene within a field of view (FOV) of the apparatus, the portion of the scene including at least one object;
determine, based on the image data, a depth map of the portion of the scene within the FOV of the apparatus including the at least one object;
determine, using the depth map, one or more planes within the portion of the scene within the FOV of the apparatus including the at least one object;
generate, using the one or more planes, at least one planar region with boundaries corresponding to boundaries of a surface of the at least one object;
generate, using the at least one planar region, a three-dimensional representation of the portion of the scene; and
update a three-dimensional representation of the scene using the three-dimensional representation of the portion of the scene, the three-dimensional representation of the scene including additional representations of additional portions of the scene generated based on additional image data associated with the additional portions of the scene.

15. The apparatus of claim 14, wherein the processor is configured to update the three-dimensional representation of the scene using the three-dimensional representation of the portion of the scene by adding the at least one planar region to the three-dimensional representation of the scene.

16. The apparatus of claim 14, wherein the processor is configured to update the three-dimensional representation of the scene using the three-dimensional representation of the portion of the scene by updating an existing planar region of the three-dimensional representation of the scene with the at least planar region.

17. The apparatus of claim 16, wherein the processor is configured to generate the existing planar region of the three-dimensional representation of the scene using image data associated with an additional portion of the scene within an additional FOV of the apparatus, and wherein the FOV of the apparatus partially intersects the additional FOV of the apparatus.

18. The apparatus of claim 17, wherein the processor is configured to determine the depth map of the portion of the scene by determining distances between points in the scene and the surface of the at least one object.

19. The apparatus of claim 18, wherein the distances are represented using a signed distance function.

20. The apparatus of claim 14, wherein the depth map includes a plurality of data points, each data point of the plurality of data points indicating a distance between an object surface and a point in the scene, and wherein the depth map is divided into a plurality of sub-volumes, each sub-volume of the plurality of sub-volumes including a predetermined number of data points.

21. The apparatus of claim 20, wherein the processor is configured to determine the one or more planes by fitting a plane equation to data points within at least one sub-volume of the depth map.

22. The apparatus of claim 21, wherein the at least one sub-volume of the depth map includes a sub-volume corresponding to points in the scene that are less than a threshold distance from the surface of the at least one object.

23. The apparatus of claim 21, wherein the processor is configured to fit the plane equation to the data points within the at least one sub-volume of the depth map by:
fitting a first plane equation to data points within a first sub-volume of the depth map and fitting a second plane equation to data points within a second sub-volume of the depth map;
determining that the first plane equation has at least a threshold similarity to the second plane equation;
determining, based on the first plane equation having at least the threshold similarity to the second plane equation, that the data points within the first sub-volume and the data points within the second sub-volume of the depth map correspond to a same plane; and
based on determining that the data points within the first sub-volume and the data points within the second sub-volume correspond to the same plane, fitting a third plane equation to the data points within the first sub-volume and the data points within the second sub-volume, wherein the third plane equation is a combination of the first and second plane equations.

24. The apparatus of claim 21, wherein the processor is configured to generate the at least one planar region by:
projecting one or more of the data points within the at least one sub-volume of the depth map onto a plane defined by the plane equation; and
determining a polygon within the plane that includes the projected one or more data points.

25. The apparatus of claim 24, wherein the processor is configured to determine the polygon within the plane by determining one of:
a convex hull that includes the projected one or more data points; or
an alpha shape that includes the projected one or more data points.

26. The apparatus of claim 14, wherein the apparatus is an extended reality device.

27. A non-transitory computer-readable storage medium having stored thereon instructions that, when executed by one or more processors, cause the one or more processors to:
obtain image data associated with a portion of a scene within a field of view (FOV) of the apparatus, the portion of the scene including at least one object;
determine, based on the image data, a depth map of the portion of the scene within the FOV of the apparatus including the at least one object;
determine, using the depth map, one or more planes within the portion of the scene within the FOV of the apparatus including the at least one object;
generate, using the one or more planes, at least one planar region with boundaries corresponding to boundaries of a surface of the at least one object;
generate, using the at least one planar region, a three-dimensional representation of the portion of the scene; and
update a three-dimensional representation of the scene using the three-dimensional representation of the portion of the scene, the three-dimensional representation of the scene including additional representations of additional portions of the scene generated based on additional image data associated with the additional portions of the scene.

28. The non-transitory computer-readable storage medium of claim 27, wherein updating the three-dimensional representation of the scene using the three-dimensional representation of the portion of the scene includes updating an existing planar region of the three-dimensional representation of the scene with the at least planar region.

29. The non-transitory computer-readable storage medium of claim 27, wherein determining the depth map of the portion of the scene includes determining distances between points in the scene and the surface of the at least one object.

30. The non-transitory computer-readable storage medium of claim 27, wherein the depth map includes a plurality of data points, each data point of the plurality of data points indicating a distance between an object surface and a point in the scene, and wherein the depth map is divided into a plurality of sub-volumes, each sub-volume of the plurality of sub-volumes including a predetermined number of data points.
